(19) United States
(12) Patent Application Publication
(10) Pub. No.: US 2008/0053414 A1
(43) Pub. Date: Mar. 6, 2008

(54) RC regulator

(76) Inventor: Roy Allen Carr, Dallas, TX (US)

Correspondence Address: Roy A. Carr, 4625 Bonnie View R.D., Dallas, TX, 75216, US

(21) Appl. No.: 11/512,129

(22) Filed: Aug. 30, 2006

(51) Int. Cl. F02M 37/00

(52) U.S. Cl. 123/514

(57) ABSTRACT

The way the R.C. Regulator works is that it lets fuel back into the fuel tank that is not needed. The pressure on the injectors will drop to the minimal. The vehicle may not start on the first start attempt, but will on the second. The R.C. Regulator does not rob the automobile of its power, which will cause it to keep its maximum performance. The automobile will have a gain of miles per. The R.C. Regulator is made of H/C PEX Tube. The R.C. Regulator has a punctured hole on the side for ventilation and sending excessive fuel back into the fuel tank for future use. The R.C. Regulator will go in between the line to the fuel injectors and the fuel pump. There are clamps used to hold the R.C. Regulator in place.

### BACKGROUND OF THE INVESTIGATION

### FIELD OF THE INVENTION

The present invention relates to an insertion of the R.C. Regulator in between the line going to the fuel injectors and the fuel pump, in order to enhance a vehicles overall miles per gallon. The hole on the side of the R.C. Regulator will send excessive fuel that is not needed back into the fuel tank for future use. More particularly, The R.C. Regulator is made of a strip of H/C PEX tube that is cut to form and shaped to fit, with clamps, in between the line to the fuel injectors and the fuel pump.

### BRIEF DESCRIPTION OF THE DRAWINGS

FIG. 1 are perspective views of the R.C. Regulator.

FIG. 2 is a perspective view of the R.C. Regulator placed between the fuel pump and the line to the injectors. It also shows the flow of fuel.

### DESCRIPTION OF THE PREFERRED EMBODIMENTS

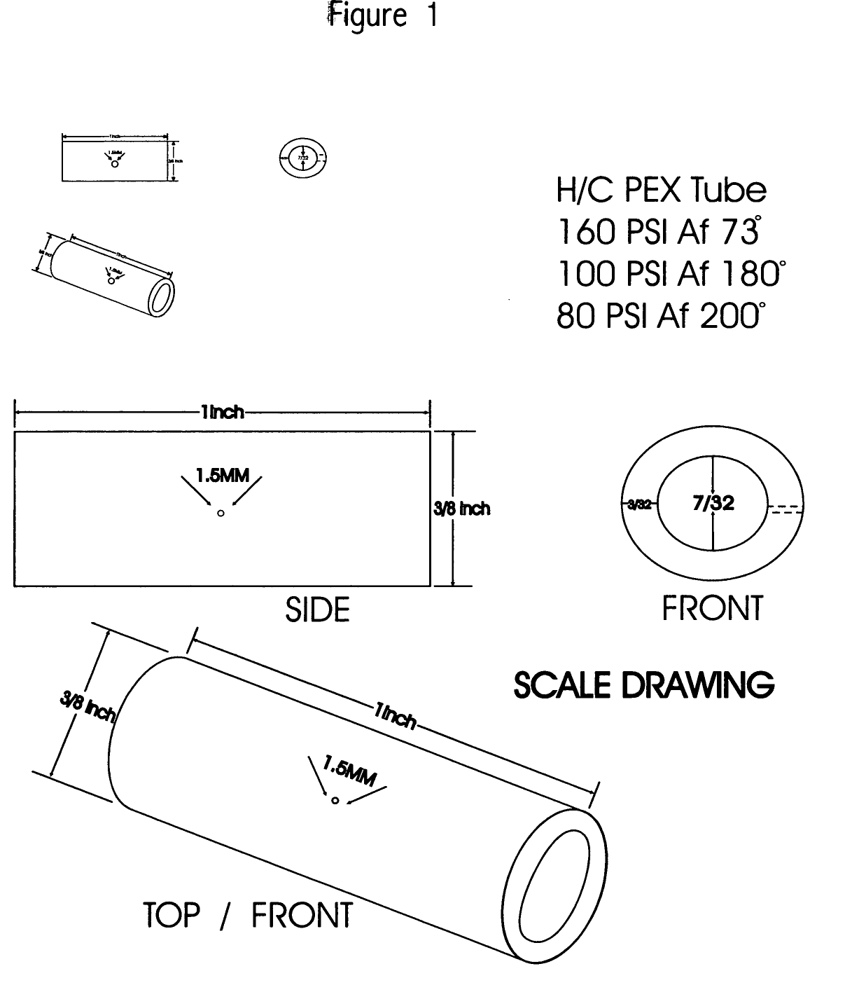

Referring to FIG. 1

Description: The RV Regulator is made of H/C PEX tube. The dimensions are as shown in the diagram. The length of the R.C. Regulator is 1 inch long. The height of the R.C. Regulator is ⅜ inch. The thickness of the R.C. Regulator is 3/32 of an inch. The punctured hole on the side of the R.C. is 1.5 MM in diameter. The hole is for excessive fuel to be rechanneled back into the gas tank of the vehicle

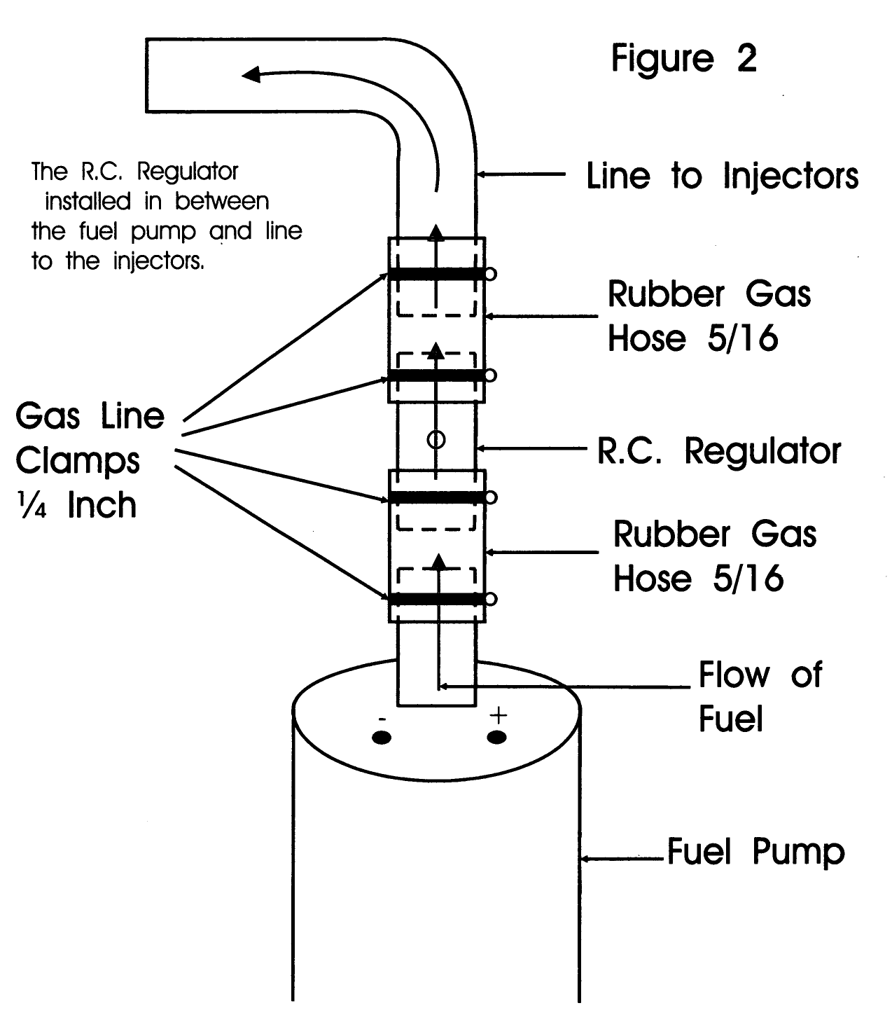

Referring to FIG. 2

Description: The R.C. Regulator is placed in between the fuel pump and the line that feeds the fuel injectors. The R.C. Regulator is held with two clamps that will hold it in place; the fuel pump and the fuel line that feed the fuel injectors will be held down by their own individual clamps. Fuel will flow back into the gas tank, excessive fuel that is not needed to fuel the automobile.

### SUMMARY OF INVENTION

The present invention is directed to increase the miles per gallon of a vehicle, vehicles with a fuel injection system in which a strip of H/C PEX Tube is cut and placed in between the fuel pump and the line to the fuel injection system. The vehicle will not lose any power; you can run the air conditioner and still get maximum gains in miles per gallon. The type of vehicles which can benefit by this device include all new and old vehicles that have a fuel injection system.

Accordingly, it is a principal object of the R.C. Regulator to provide miles per gallon gain for use inline with the fuel pump and the line to the fuel injection system.

It is another object of the invention to provide an R.C. Regulator which is made from a cut and formed H/C PEX Tube/

It is a further object of the invention to provide an R.C. Regulator for use in fuel injection equipped vehicles, in which the device includes a punctured hole, which will send excessive fuel back into the fuel tank for future use.

It is an object of the invention to provide improved elements and arrangements thereof in an apparatus for the purposes described which are dependable and fully effective in accomplishing its intending purposes.

These and other objects of the present invention will become readily apparent upon further review of the following specification and drawings.

I claim:

1. The R.C. Regulator is used in between the line to the fuel injectors and the fuel pump, comprising: a vehicle having an injection system and a fuel pump.

2. The R.C. Regulator according to claim 1, wherein said is made from a single 1 inch long strip of H/C PEX tube.

3. The R.C. Regulator according to claim 1, wherein said has a thickness of 3/32 inches.

4. The R.C. Regulator according to claim 1, wherein said has a height of ⅜ inches.

5. The R.C. Regulator according to claim 1, wherein said has a thickness of 3/32 inches.

6. The R.C. Regulator according to claim 1, wherein said has an inside diameter of 7/32 inches.

7. The R.C. Regulator according to claim 1, wherein said has a circular hole in the middle of 1.5 MM diameter.

8. The R.C. Regulator according to claim 1, wherein said has a circular hole on the backside middle of 1.5 MM diameter.

9. The R.C. Regulator according to claim 1, wherein said has an oval hole in the middle of 1.5 MM diameter.

10. The R.C. Regulator according to claim 1 wherein said has an oval hole on the backside middle of 1.5 MM diameter.

11. The R.C. Regulator according to claim 1, wherein said has a square hole in the middle of 1.5 MM diameter.

12. The R.C. Regulator according to claim 1, wherein said has a square hole on the backside middle of 1.5 MM diameter.

13. The R.C. Regulator according to claim 1, wherein said has a star hole in the middle of 1.5 MM diameter.

14. The R.C. Regulator according to claim 1, wherein said has a star hole on the backside middle of 1/16 diameter.
